(19) United States
(12) Patent Application Publication
(10) Pub. No.: US 2005/0026527 A1
(43) Pub. Date: Feb. 3, 2005

(54) Nonwoven containing acoustical insulation laminate

(76) Inventors: Richard John Schmidt, Roswell, GA (US); Jeffrey A. Tilton, Prospect, KY (US)

Correspondence Address: KIMBERLY-CLARK WORLDWIDE, INC., 401 NORTH LAKE STREET, NEENAH, WI, 54956, US

(21) Appl. No.: 10/629,099

(22) Filed: Jul. 29, 2003

Related U.S. Application Data
(60) Provisional application No. 60/401,125, filed on Aug. 5, 2002.

(51) Int. Cl. D04H 1/00; D04H 3/00; D04H 5/00; D04H 13/00; D02G 3/00; B32B 5/26; B32B 5/06; D04H 1/56; D04H 3/16

(52) U.S. Cl. 442/381; 442/382; 442/389; 442/390; 442/400; 442/401; 442/340; 442/347; 442/352; 442/353; 442/362; 428/369; 428/373; 428/374; 428/365; 428/364

(57) ABSTRACT

The present invention relates to an acoustical insulation material containing a first layer formed from a nonwoven web having a density of at least 50 kg/m³ wherein the nonwoven web is formed from thermoplastic [meltblown] fibers having an average fiber diameter of less than about 7 microns; and a second layer of a high loft material. The high loft material of the present invention provides bulk to the first layer and may or may not have sound attenuating properties. Examples of the high loft material include, for example, fiberglass and high loft nonwoven webs. Also disclosed in a method of attenuating sound waves passing from a sound source area to a second area. The method includes positioning an acoustical insulation material containing a first layer formed from a nonwoven web having a density of at least 50 kg/m³ wherein the nonwoven web is formed from thermoplastic [meltblown] fibers having an average fiber diameter of less than about 7 microns; and a second layer of a high loft material, between the sound source area and the second area.

This application claims priority from U.S. Provisional Application No. 60/401,125, filed Aug. 5, 2002.

### FIELD OF THE INVENTION

The present invention relates to a nonwoven acoustical insulation material which can be used as acoustical insulation in vehicles, appliances, architectural applications and other locations where sound attenuation is desired or required.

### BACKGROUND OF THE INVENTION

Many different sound insulation materials are available in the art. These materials have been used in a variety of applications, for example, to reduce noise from appliances, within buildings, from HVAC systems, within vehicles and the like. The selection of a particular sound insulation material is governed by several factors, including cost, thickness, weight and the ability to attenuate sound. Sound insulation attenuates sound by either absorbing sound waves striking the insulation or reflecting such sound waves outwardly and away from a receiving area. Sound attenuation is measured by the ability of a material to absorb incident sound waves (sound absorption) and/or by the ability of the material to reflect incident sound waves (transmission). Ideally, a sound attenuation material has a high sound absorption coefficient and/or a high transmission loss value.

Conventional sound insulating materials include materials such as foams, compressed fibers, fiberglass batts, felts and nonwoven webs of fibers. Of the nonwoven webs of fibers, meltblown fibers have been widely used in sound insulation materials. In addition, laminates of meltblown nonwoven webs have been used as acoustical insulation.

In these prior uses of meltblown nonwoven webs in acoustical insulation, the meltblown nonwoven web typically was a relatively thick, low density layer of meltblown fibers, usually having a thickness of at least 5 mm and a density less than 50 kg/m³.

Examples of such meltblown containing acoustical insulation are described in U.S. Pat. Nos. Re 36,323 to Thompson et al.; U.S. Pat. No. 5,773,375 to Thompson et al.; U.S. Pat. No. 5,841,081 to Thompson et al. These patents teach laminates containing meltblown fibers; however, the laminates have the problem of dimensional stability, meaning that the laminate does not retain its shape during handling, including compaction of the fibers and tearing or breaking of parts molded out of this material.

Another acoustical insulation containing meltblown fibers is described in U.S. Pat. No. 6,217,691 to Vair et al. In this patent, a mat of meltblown fibrous insulation is produced from meltblown fibers having a mean fiber diameter of less than 13 microns, a density less than about 60 kg/m³, preferably less than about 50 kg/m³, and a thickness between 3 and 20 mm. In the production of acoustical insulation, the fibers at least one of the top and bottom surfaces of the meltblown are melted to form a thin integral skin. The resulting material is then point bonded to provide integrity to the mat. In addition, the integral skin layer is perforated to provide air permeability to the mat.

In U.S. Pat. No. 3,773,605 to Pihistrom, an acoustical insulation material is produced by fusing and integrating several layers of a meltblown nonwoven web to form a panel having a density between 0.01 and about 0.3 g/cc. The resulting nonwoven web has a thickness greater than about 7 mm.

In U.S. Pat. No. 5,431,992 to Houpt et al. (hereby incorporated by reference in its entirety), a bicomponent fibrous insulation material is disclosed. The fibers of the insulation have an irregular curl due to the difference between the coefficients of thermal expansion between the two materials. The irregular fibers are sufficiently entangled such that the insulation has structural integrity. Irregularly shaped fibers may be used as formed or may be formed into mats as disclosed in U.S. Pat. No. 5,935,879 or 5,972,166 (hereby incorporated by reference in their entirety).

### SUMMARY OF THE INVENTION

The present invention relates to an acoustical insulation material containing a first layer formed from a nonwoven web having a density greater than about 50 kg/m³ wherein the nonwoven web is formed from thermoplastic filaments having an average fiber diameter of less than about 7 microns; and a second layer of a high loft material. The high loft material of the present invention provides bulk to the first layer and may or may not have sound attenuating properties. Examples of the high loft material include, for example, fiberglass and high loft nonwoven webs. The present invention also relates to a method of attenuating sound waves passing from a sound source area to a second area. The method includes positioning an acoustical insulation material containing a first layer formed from a nonwoven web having a density greater than about 50 kg/m³ wherein the nonwoven web is formed from thermoplastic filaments having an average fiber diameter of less than about 7 microns; and a second layer of a high loft material, between the sound source area and the second area.

In the present invention, an advantageous high loft material is a lofty nonwoven web produced from crimped multicomponent spunbond filaments. The crimp of these filaments may be activated while the filaments are in the draw unit or after the filaments have been laid-down on a forming surface. In addition, it is also advantageous for the thermoplastic filaments of the first layer to be thermoplastic meltblown filaments.

The present invention also includes articles of manufacture including the sound insulation material of the present invention.

### BRIEF DESCRIPTION OF THE DRAWINGS

FIG. 1 shows a schematic diagram of the process of producing a preferred high loft material of the present invention.

FIGS. 2A and 2B show the sound absorption coefficient for the laminate of the present invention and high loft material alone, respectively.

### DEFINITIONS

As used herein, the term “comprising” is inclusive or open-ended and does not exclude additional unrecited elements, compositional components, or method steps.

As used herein, the term “fiber” includes both staple fibers, i.e., fibers which have a defined length between about 19 mm and about 50 mm, fibers longer than staple fiber but are not continuous, and continuous fibers, which are sometimes called “substantially continuous filaments” or simply “filaments”. The method in which the fiber is prepared will determine if the fiber is a staple fiber or a continuous filament.

As used herein, the term “nonwoven web” means a web having a structure of individual fibers or threads which are interlaid, but not in an identifiable manner as in a knitted web. Nonwoven webs have been formed from many processes, such as, for example, meltblowing processes, spunbonding processes, air-laying processes, coforming processes and bonded carded web processes. The basis weight of nonwoven webs is usually expressed in ounces of material per square yard (osy) or grams per square meter (gsm) and the fiber diameters useful are usually expressed in microns, or in the case of staple fibers, denier. It is noted that to convert from osy to gsm, multiply osy by 33.91.

As used herein, the term “meltblown fibers” means fibers formed by extruding a molten thermoplastic material through a plurality of fine, usually circular, die capillaries as molten threads or filaments into converging high velocity, usually hot, gas (e.g. air) streams which attenuate the filaments of molten thermoplastic material to reduce their diameter, which may be to microfiber diameter. Thereafter, the meltblown fibers are carried by the high velocity gas stream and are deposited on a collecting surface to form a web of randomly dispersed meltblown fibers. Such a process is disclosed, for example, in U.S. Pat. No. 3,849,241 to Butin, which is hereby incorporated by reference in its entirety. Meltblown fibers are microfibers, which may be continuous or discontinuous, and are generally smaller than 10 microns in average diameter The term “meltblown” is also intended to cover other processes in which a high velocity gas, (usually air) is used to aid in the formation of the filaments, such as melt spraying or centrifugal spinning.

As used herein the term “spunbond fibers” refers to small diameter fibers of molecularly oriented polymeric material. Spunbond fibers may be formed by extruding molten thermoplastic material as filaments from a plurality of fine, usually circular capillaries of a spinneret with the diameter of the extruded filaments then being rapidly reduced as in, for example, U.S. Pat. No. 4,340,563 to Appel et al., and U.S. Pat. No. 3,692,618 to Dorschner et al., U.S. Pat. No. 3,802,817 to Matsuki et al., U.S. Pat. Nos. 3,338,992 and 3,341,394 to Kinney, U.S. Pat. No. 3,502,763 to Hartman, U.S. Pat. No. 3,542,615 to Dobo et al, and U.S. Pat. No. 5,382,400 to Pike et al. Spunbond fibers are generally not tacky when they are deposited onto a collecting surface and are generally continuous.

Spunbond fibers are often about 10 microns or greater in diameter. However, fine fiber spunbond webs (having an average fiber diameter less than about 10 microns) may be achieved by various methods including, but not limited to, those described in commonly assigned U.S. Pat. No. 6,200,669 to Marmon et al. and U.S. Pat. No. 5,759,926 to Pike et al., each is hereby incorporated by reference in its entirety.

“Bonded carded web” refers to webs that are made from staple fibers which are sent through a combing or carding unit, which separates or breaks apart and aligns the staple fibers in the machine direction to form a generally machine direction-oriented fibrous nonwoven web. Such fibers are usually purchased in bales which are placed in an opener/blender or picker which separates the fibers prior to the carding unit. Once the web is formed, it then is bonded by one or more of several known bonding methods. One such bonding method is powder bonding, wherein a powdered adhesive is distributed through the web and then activated, usually by heating the web and adhesive with hot air. Another suitable bonding method is pattern bonding, wherein heated calender rolls or ultrasonic bonding equipment are used to bond the fibers together, usually in a localized bond pattern, though the web can be bonded across its entire surface if so desired. Another suitable and well-known bonding method, particularly when using bicomponent staple fibers, is through-air bonding.

“Airlaying” or “airlaid’ is a well known process by which a fibrous nonwoven layer can be formed. In the airlaying process, bundles of small fibers having typical lengths ranging from about 3 to about 19 millimeters (mm) are separated and entrained in an air supply and then deposited onto a forming screen, usually with the assistance of a vacuum supply. The randomly deposited fibers then are bonded to one another using, for example, hot air or a spray adhesive.

As used herein, the term “polymer” generally includes, but is not limited to, homopolymers, copolymers, such as for example, block, graft, random and alternating copolymers, terpolymers, etc. and blends and modifications thereof. Furthermore, unless otherwise specifically limited, the term “polymer” shall include all possible geometrical configurations of the molecule. These configurations include, but are not limited to isotactic, syndiotactic and random symmetries.

As used herein, the term “multicomponent fibers” refers to fibers or filaments which have been formed from at least two materials. Multicomponent polymer fibers are extruded from separate extruders but spun together to form one fiber. Multicomponent fibers are also sometimes referred to as “conjugate” or “bicomponent” fibers or filaments. The term “bicomponent” means that there are two components making up the fibers. Bicomponent polymer fibers are usually forms of polymers that are different from each other, although conjugate fibers may be prepared from the same polymer, if the polymer in each component is different from one another in some physical property, such as, for example, melting point or the softening point. In all cases, the polymers are arranged in substantially constantly positioned distinct zones across the cross-section of the multicomponent fibers or filaments and extend continuously along the length of the multicomponent fibers or filaments. The configuration of such a multicomponent fiber may be, for example, a sheath/core arrangement, wherein one polymer is surrounded by another, a side-by-side arrangement, a pie arrangement or an “islands-in-the-sea” arrangement. Multicomponent fibers are taught in U.S. Pat. No. 5,108,820 to Kaneko et al.; U.S. Pat. No. 5,336,552 to Strack et al.; and U.S. Pat. No. 5,382,400 to Pike et al.; the entire content of each is incorporated herein by reference. For two component fibers or filaments, the polymers may be present in ratios of 75/25, 50/50, 25/75 or any other desired ratios. The multicomponent fibers can also be prepared from tow different glass materials in similar configurations.

As used herein, the term “multiconstituent fibers” refers to fibers which have been formed from at least two [polymers] materials extruded from the same extruder as a blend or mixture. Multiconstituent fibers do not have the various components arranged in relatively constantly positioned distinct zones across the cross-sectional area of the fiber and the various materials are usually not continuous along the entire length of the fiber, instead usually forming fibrils or protofibrils which start and end at random. The materials may be polymeric or glass materials.

As used herein, the term “pattern bonded” refers to a process of bonding a nonwoven web in a pattern by the application of heat and pressure or other methods, such as ultrasonic bonding. Thermal pattern bonding typically is carried out at a temperature in a range of from about 80° C. to about 180° C. and a pressure in a range of from about 150 to about 1,000 pounds per linear inch (59-178 kg/cm). The pattern employed typically will have from about 10 to about 250 bonds/inch² (1-40 bonds/cm²) covering from about 5 to about 30 percent of the surface area. Such pattern bonding is accomplished in accordance with known procedures. See, for example, U.S. Design Pat. No. 239,566 to Vogt, U.S.

Design Pat. No. 264,512 to Rogers, U.S. Pat. No. 3,855,046 to Hansen et al., and U.S. Pat. No. 4,493,868, supra, for illustrations of bonding patterns and a discussion of bonding procedures, which patents are incorporated herein by reference. Ultrasonic bonding is performed, for example, by passing the multilayer nonwoven web laminate between a sonic horn and anvil roll as illustrated in U.S. Pat. No. 4,374,888 to Bornslaeger, which is hereby incorporated by reference in its entirety.

As used herein, the phrase “high loft material” refers to a material which has a z-direction thickness generally in excess of about 3 mm and a relatively low bulk density. The thickness or bulk of the high loft material web is measured at 0.05 psi (3.5 g/cm³) with a STARRET-7 type bulk tester. Samples were cut into 4 inch by 4 inch (10.2 cm by 10.2 cm) squares and five samples were tested to determine bulk or thickness. Preferably, the high loft material has a thickness greater than about 4 mm. The bulk density is calculated by dividing the basis weight of the material by the bulk. The bulk density of high loft webs is typically less than about 50 kg/m³.

As used herein, the phrase “sound attenuation” refers to absorption and/or reflection of incident sound waves.

As used herein, the phrase “article of manufacture” refers to an article other than the sound insulation material of the present invention. Articles of manufacture include, for example, small appliances, such as blenders, food processors and the like; larger appliances, such as dish washers, refrigerators, clothes washing machines and the like; vehicles, such as automobiles, trucks, airplanes and the like; and buildings. Other articles which are intended to be included in this definition include articles which may be in need of sound attenuation properties.

### DETAILED DESCRIPTION

The present invention provides an acoustical insulation material containing a first layer formed from a nonwoven web having a density greater than about 50 kg/m³ wherein the nonwoven web is formed from thermoplastic fibers having an average fiber diameter of less than about 7 microns; and a second layer of a high loft material. The high loft material of the present invention provides bulk to the first layer and may or may not have sound attenuating properties. Generally, however, is it preferred that the high loft material does have some sound attenuating properties.

The first layer of the acoustical insulation of the present is preferably prepared using a meltblowing process which forms a “meltblown” nonwoven web. Although the invention is described below in terms of the first layer of the acoustical insulation being prepared from a meltblown nonwoven web, the nonwoven web may be prepared by other processes provided that the thermoplastic fibers have the average fiber diameter discussed below and the acoustical insulation material has the specified density.

Meltblown nonwoven webs are known in the art and have been used in a wide variety of applications, including acoustical insulation. The meltblown nonwoven web of the acoustical insulation of the present invention is characterized in that it contains relatively closely distributed meltblown fibers that are randomly dispersed and autogenously bonded. These properties are responsible for the relatively high pressure drop and low permeability, which are believed to be at least partially responsible for the sound attenuating properties to the acoustical material. The meltblown nonwoven web is very effective as an acoustical insulation material, despite the low thickness and high density of the nonwoven web.

The thermoplastic meltblown fibers have an average fiber diameter of less than about 7 microns. Preferably, the thermoplastic meltblown fibers have an average fiber diameter less than about 5 microns and more preferably between about 1.0 microns to about 4.0 microns and most preferably between about 2.0 microns to about 3.0 microns. If the average fiber diameter is greater than about 7 microns, the permeability of the acoustical insulation tends to be increased and the pressure drop of the acoustical insulation tends to be decreased, which generally corresponds to a decrease in the sound attenuating properties.

The first layer of the acoustical insulation material of the present invention has a density of at least about 50 kg/m³. The upper limit of the density is not critical to the present invention; however, from a practical standpoint of producing the meltblown nonwoven webs, the upper limit for the density is about 250 kg/m³. Ideally, the density for the acoustical insulation material is between about 55 kg/m³ and about 150 kg/m³ and preferably about 58 kg/m³ to about 100 kg/m³.

In the present invention, the thickness of the first layer is not critical to the invention, As is noted in the Background of the Invention, it has been generally preferred in the sound attenuation art that the acoustical insulation has a thickness greater than about 3 mm.

Surprisingly, it has been discovered that a nonwoven web having a thickness less than 3 mm has sound attenuating properties. It has been discovered that first layer of the acoustical insulation material of the present invention made from a nonwoven web having a thickness as low as about 0.2 mm will impart sound attenuating properties to the laminate of the present invention, provided that the meltblown fibers have a fiber diameter less than about 7 microns and the density of the nonwoven web is at least 50 kg/m³. From a standpoint of cost and ability to prepare the high density and low loft meltblown nonwoven, a thickness of up to about 3 mm is practical to produce. Higher thickness could be produced, however the cost of production would dramatically rise. It is preferred that the meltblown nonwoven web sound attenuating material of the present invention has a thickness of about 0.2 mm to about 2.5 mm, more preferably between about 0.3 mm and 1.0 mm. The thickness of the acoustical insulation material is measured at 0.05 psi (3.5 g/cm³) with a STARRET-7 type bulk tester. Samples were cut into 4 inch by 4 inch (10.2 cm by 10.2 cm) squares and five samples were tested to determine bulk or thickness.

The thermoplastic fibers of the first layer may be prepared from polymeric or glass materials. The thermoplastic fibers of the first layer are preferably prepared from thermoplastic polymers. Suitable thermoplastics [polymers] useful in the present invention include polyolefins, polyesters, polyamides, polycarbonates, polyurethanes, polyvinylchloride, polytetrafluoroethylene, polystyrene, polyethylene terephathalate, glass, biodegradable polymers such as polylactic acid and copolymers, and blends thereof. Suitable polyolefins include polyethylene, e.g., high density polyethylene, medium density polyethylene, low density polyethylene and linear low density polyethylene; polypropylene, e.g., isotactic polypropylene, syndiotactic polypropylene, blends of isotactic polypropylene and atactic polypropylene, and blends thereof; polybutylene, e.g., poly(1-butene) and poly(2-butene); polypentene, e.g., poly(1-pentene) and poly(2-pentene); poly(3-methyl-1-pentene); poly(4-methyl 1-pentene); and copolymers and blends thereof. Suitable copolymers include random and block copolymers prepared from two or more different unsaturated olefin monomers, such as ethylene/propylene and ethylene/butylene copolymers. Suitable polyamides include nylon 6, nylon 6/6, nylon 4/6, nylon 11, nylon 12, nylon 6/10, nylon 6/12, nylon 12/12, copolymers of caprolactam and alkylene oxide diamine, and the like, as well as blends and copolymers thereof. Suitable polyesters include polyethylene terephthalate, polytrimethylene terephthalate, polybutylene terephthalate, polytetramethylene terephthalate, polycyclohexylene-1,4-dimethylene terephthalate, and isophthalate copolymers thereof, as well as blends thereof.

Many polyolefins are available for fiber production, for example polyethylenes such as Dow Chemical's ASPUN 6811A linear low-density polyethylene, 2553 LLDPE and 25355 and 12350 high density polyethylene are such suitable polymers. The polyethylenes have melt flow rates in g/10 min. at 1900 F. and a load of 2.16 kg, of about 26, 40, 25 and 12, respectively. Fiber forming polypropylenes include, for example, Basell's PF-015 polypropylene. Many other polyolefins are commercially available and generally can be used in the present invention. The particularly preferred polyolefins are polypropylene and polyethylene.

Examples of polyamides and their methods of synthesis may be found in “Polymer Resins” by Don E. Floyd (Library of Congress Catalog number 66-20811, Reinhold Publishing, N.Y., 1966). Particularly commercially useful polyamides are nylon 6, nylon-6,6, nylon-11 and nylon-12. These polyamides are available from a number of sources such as Custom Resins, Nyltech, among others. In addition, a compatible tackifying resin may be added to the extrudable compositions described above to provide tackified materials that autogenously bond or which require heat for bonding. Any tackifier resin can be used which is compatible with the polymers and can withstand the high processing (e.g., extrusion) temperatures. If the polymer is blended with processing aids such as, for example, polyolefins or extending oils, the tackifier resin should also be compatible with those processing aids. Generally, hydrogenated hydrocarbon resins are preferred tackifying resins, because of their better temperature stability. REGALREZ® and ARKON® P series tackifiers are examples of hydrogenated hydrocarbon resins. ZONATAC® 501 Lite is an example of a terpene hydrocarbon. REGALREZ® hydrocarbon resins are available from Hercules Incorporated. ARKON® P series resins are available from Arakawa Chemical (USA) Incorporated. The tackifying resins such as disclosed in U.S. Pat. No. 4,787,699, hereby incorporated by reference, are suitable. Other tackifying resins which are compatible with the other components of the composition and can withstand the high processing temperatures, can also be used.

The meltblown fibers may be monocomponent fibers, meaning fibers prepared from one polymer component, multiconstituent fibers, or multicomponent fibers. The multicomponent fibers may have either of an A/B or A/B/A side-by-side configuration, a pie configuration or a sheath-core configuration, wherein one polymer component surrounds another polymer component. Any of the above described thermoplastic polymers may be used as each component of the multicomponent fibers. Selection of the thermoplastic polymers of multicomponent fibers can change the properties of the resulting fibers. For example, if the thermoplastic components are incompatible with one another, the bicomponent fibers may be split to form finer fibers with a stimulus, such as heat or high pressure water. Examples of possible splitting methods are described in detail in U.S. Pat. No. 5,759,926 to Pike et al., which is hereby incorporated by reference in its entirety. If the melting points of the individual thermoplastic polymers are different from one other, it is possible to crimp the fibers by applying heat to activate the crimp. In forming the bicomponent fibers which can be used as the meltblown fibers of the present invention, it is desirable to produce fibers which are splittable, to drive down the average fiber diameter of the fibers upon splitting. If split fibers are not desired, it is generally preferred to use side-by-side fibers from similar polymers, such as polyolefins. A preferred multicomponent fiber configuration is a side-by-side multicomponent filament where at least one component contains polyethylene and at least one component contains polypropylene.

The meltblown nonwoven web used in the first layer of the acoustical insulation material can be made by any process known in the art. An exemplary process is disclosed in U.S. Pat. No. 3,849,241 to Butin et al., where air-borne fibers, which are not fully quenched, are carried by a high velocity gas stream and deposited on a collecting surface to form a web of randomly dispersed and autogenously bonded meltblown fibers. As is known in the art, the flow rate, temperature and pressure of the high velocity gas stream can be adjusted to form continuous meltblown fibers or discontinuous fibers. In addition, the flow rate, temperature and pressure of the high velocity gas stream can be adjusted to change the average fiber diameter and other properties of the fibers. The meltblown nonwoven web may be formed using a single meltblown die or a series of meltblown dies.

The physical attributes, such as abrasion resistance or tear strength, of the acoustical insulation can be improved by pattern bonding the meltblown nonwoven web, or other process such as meltblowing a layer of meltblown fibers having an average fiber diameter greater than about 10 microns. Pattern bonding can be accomplished by thermal bonding or ultrasonic bonding.

Alternatively, the surface of the first layer can be made abrasive and/or abrasion resistant by meltblowing a relatively light layer of coarse meltblown fibers onto the surface of the meltblown nonwoven web. This may be accomplished by adding a second meltblown die in line with the meltblown die producing the fine fiber meltblown nonwoven web or by rolling the nonwoven web of the fine fibers and unrolling the fine fiber meltblown and meltblowing the coarse meltblown fibers onto the fine fiber meltblown, such as the process shown in U.S. Pat. No. 4,659,609 to Lamers et al, which is hereby incorporated by reference. In the practice of this invention, the average fiber diameter of the coarse meltblown fibers is at least about 10 microns, and preferably between about 15 microns and about 39 microns.

As is known in the art, the characteristics of the meltblown fibers can be adjusted by manipulation of the various process parameters used for each extruder and die head in carrying out the meltblowing process. The following parameters can be adjusted and varied for each extruder and die head in order to change the characteristics of the resulting meltblown fibers:
1. Type of Polymer,
2. Polymer throughput (pounds per inch of die width per hour—PIH),
3. Polymer melt temperature,
4. Air temperature,
5. Air flow (standard cubic feet per minute, SCFM, calibrated the width of the die head),
6. Distance from between die tip and forming belt and
7. Vacuum under forming belt.

An additional advantage of using a fine fiber meltblown layer in the acoustical insulation of the present invention is that the fine fiber meltblown also act as a moisture barrier, preventing moisture from passing through the insulation material. Even though that the acoustical insulation has these moisture barrier properties, the material still allows for air to pass through the structure.

The second layer of the acoustical insulation is a high loft layer of a material which may or may not have sound attenuation properties. Preferably, the high loft material does exhibit some sound attenuation properties. Examples of the high loft material of the second layer include, for example, fiberglass batts, lofty nonwoven webs from staple fiber, lofty nonwoven webs from continuous spunbond filaments, and other high loft batts, such as polyester high lofts.

The high loft layer will generally have a thickness or loft in excess of 3 mm. The upper limit for the thickness of the high loft layer is dependent of the final use of the sound insulation material and is generally limited by the space which needs to be filled to attenuate sound. For example, in a house with 2×4 construction, the upper limit will be the thickness of the walls which would be the nominal thickness of the 2×4 of 3.5 inches (8.9 cm). From a practical standpoint, the upper limit of the thickness of the high loft layer should be usually less than about 30.5 cm. For most applications, the thickness of the high loft layer is generally between about 5 mm and about 200 mm, preferably between about 9 mm and about 100 mm, and most preferably between about 12 mm and about 25 mm. Again, the final utility of the sound insulation material will dictate the thickness of the high loft layer.

At a minimum, the high loft layer fills a cavity and helps hold the first layer in place during use.

The high loft layer preferably has a density less than 50 kg/m³, more preferably less than about 30 kg/m³, and most preferably less than about 20 kg/m³. The low density is preferred to reduce the overall weight of the material, which is important for applications where sound attenuation is needed and weight is a concern, such as in airplanes, automobiles, ships and appliances. The lower limit of the density of the second layer does not appear to be critical to the present invention; however, from a practical standpoint, the lower limit is generally about 1.0 kg/m³.

Fiberglass materials usable as the high loft layer of the present invention are available from, for example OwensCorning. Materials include the sound attenuation batts of fiberglass and other similar fiberglass products.

The high loft layer may also be bicomponent fibers using the method taught in U.S. Pat. No. 5,618,327 to Aschenbeck et al., which is hereby incorporated by reference in its entirety. The thermoplastics used in the manufacturing the fibers in U.S. Pat. No. 5,618,327 are typically glass materials having differential coefficients of thermal expansion, although and suitable thermoplastics may be used.

The high loft layer may also be prepared from staple fibers using an air-laying process or a bonded carded web process. In both processes, multicomponent staple binder fibers are laid or carded onto a forming wire. Additional fibers may optionally be admixed with the binder fibers. Desirably, at least 50 weight percent of the fibers should be binder fibers in both the air-laying process and the bonded card web process. Examples of a high loft structure prepared from staple fibers including multicomponent fiber are taught in U.S. Pat. No. 4,837,067 to Carey et al. which is hereby incorporated by reference in its entirety. The components of the multicomponent binder fibers may be any thermoplastic polymer described above for the fibers of the first layer. The binder fibers may have a sheath/core configuration or a side-by-side configuration and the actual configuration is not critical to the present invention.

The high loft material of the second layer may also be prepared from continuous filaments, such as produced by a spunbonding process. In order to obtain a lofty structure, it is generally preferred that the continuous spunbond filaments are prepared from multicomponent filaments. Preferably, the multicomponent filaments are crimped or crimpable to give a high loft structure. The high loft spunbond nonwoven web can be produced using the process described in U.S. Pat. No. 5,382,400 to Pike et al., which is herein incorporated by reference in its entirety. The process of Pike is referred to as a pre web formation crimping processes, wherein the latent helical crimp is activated while the filaments are under tension before the filaments are laid-down on a forming wire.

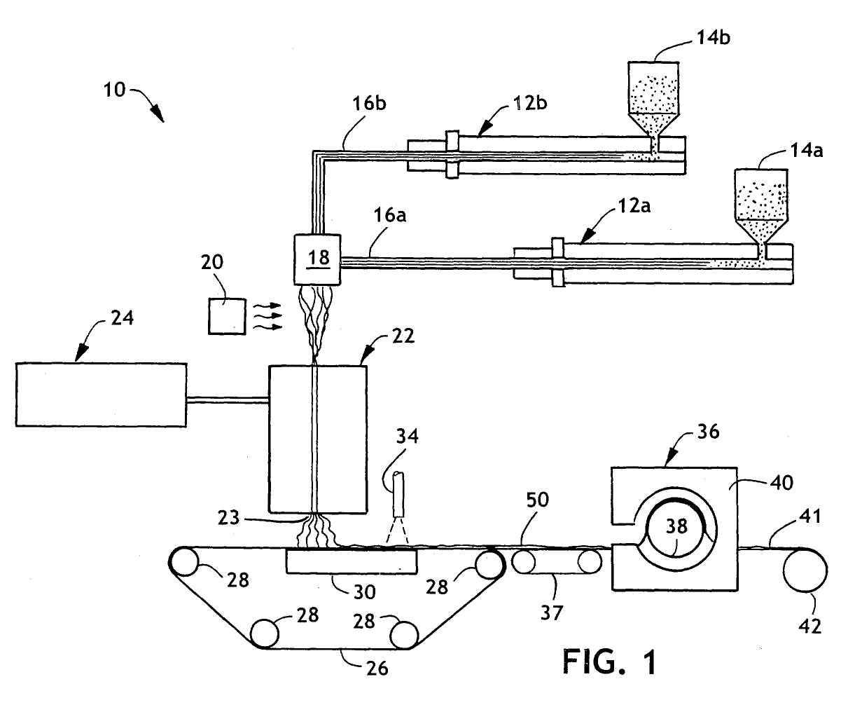

The high loft spunbond nonwoven web may be prepared by another process in which the latent crimp is activated after web formation but before bonding of the nonwoven web. To obtain a better understanding of this process, attention is directed to FIG. 1. FIG. 1 shows a schematic diagram illustrating methods and apparatus of this invention for producing high loft, low density materials by producing crimpable substantially continuous multicomponent filaments and causing filaments to crimp in an unrestrained environment.

Turning to FIG. 1, a process line 10 for preparing post formation crimp activated high loft material of the present invention is disclosed. The process line 10 is arranged to produce bicomponent continuous filaments, but it should be understood that the present invention comprehends nonwoven fabrics made with multicomponent filaments having more than two components. For example, the fabric of the present invention can be made with filaments having three or four components. The filaments may have a sheath/core, a pie or a side-by-side configuration. Generally, in order to obtain crimped filaments, the configuration of the filaments should be side-by-side or an eccentric sheath/core arrangement. It is noted; however, that the sheath component should have a lower melting point than the core component for filaments in a sheath/core configuration.

The process line 10 includes a pair of extruders 12a and 12b for separately extruding polymer component A and polymer component B. For the purposes of this description, it is assumed that polymer component A has a higher melting point than polymer component B.

Polymer component A is fed into the respective extruder 12a from a first hopper 14a and polymer component B is fed into the respective extruder 12b from a second hopper 14b.

Polymer components A and B are fed from the extruders 12a and 12b through respective polymer conduits 16a and 16b to a spinneret 18. Spinnerets for extruding bicomponent filaments are well-known to those of ordinary skill in the art and thus are not described here in detail.

Generally described, the spinneret 18 includes a housing containing a spin pack which includes a plurality of plates stacked one on top of the other with a pattern of openings arranged to create flow paths for directing polymer components A and B separately through the spinneret. The spinneret 18 has openings arranged in one or more rows. The spinneret openings form a downwardly extending curtain of filaments when the polymers are extruded through the spinneret. For the purposes of the present invention, spinneret 18 may be arranged, for example, to form side-by-side or sheath/core bicomponent filaments.

The process line 10 also includes a quench blower 20 positioned adjacent the curtain of filaments extending from the spinneret 18. Air from the quench air blower 20 quenches the filaments extending from the spinneret 18. The quench air can be directed from one side of the filament curtain as shown in FIG. 1, or both sides of the filament curtain.

A fiber draw unit (“FDU”) or aspirator 22 is positioned below the spinneret 18 and receives the quenched filaments. Fiber draw units or aspirators for use in melt spinning polymers are well-known as discussed above. Suitable fiber draw units for use in the process of the present invention include a linear fiber aspirator of the type shown in U.S. Pat. No. 3,802,817 and eductive guns of the type shown in U.S. Pat. Nos. 3,692,618 and 3,423,266, which are hereby incorporated herein by reference in their entirety. Generally described, the fiber draw unit 22 includes an elongate vertical passage through which the filaments are drawn by aspirating air entering from the sides of the passage and flowing downwardly through the passage. A blower 24 supplies aspirating air to the fiber draw unit 22. The aspirating air draws the filaments and ambient air through the fiber draw unit. The aspirating air in the formation of the post formation crimped filaments is unheated and is at or about ambient temperature. The ambient temperature may vary depending on the conditions surrounding the apparatus used in the process of FIG. 1. Generally, the ambient air is in the range of about 65° F. to about 85° F.; however, the temperature may be slightly above or below this range.

An endless forming surface 26 is positioned below the fiber draw unit 22 and receives the continuous filaments from the outlet opening 23 of the fiber draw unit. The forming surface 26 is a belt and travels around guide rollers 28. A vacuum 30 positioned below the forming surface 26 where the filaments are deposited draws the filaments against the forming surface. Although the forming surface 26 is shown as a belt in FIG. 1, it should be understood that the forming surface can also be in other forms such as a drum.

The filaments of the nonwoven web are then optionally heated by traversal under one of a hot air knife (HAK) or hot air diffuser 34. Generally, it is preferred that the filaments of the nonwoven web are heat treated. A conventional hot air knife includes a mandrel with a slot that blows a jet of hot air onto the nonwoven web surface. Such hot air knives are taught, for example, by U.S. Pat. No. 5,707,468 to Arnold, et al. A hot air diffuser is an alternative to the HAK which operates in a similar manner but with lower air velocity over a greater surface area and thus uses correspondingly lower air temperatures. Depending on the conditions of the hot air diffuser or hot air knife (temperature and air flow rate) the filaments may receive an external skin melting or a small degree of bonding during this traversal through the first heating zone. This bonding is usually only sufficient only to hold the filaments in place during further processing; but light enough so as to not hold the fibers together when they need to be manipulated manually. Compaction of the nonwoven web should be avoided as much as possible. Such bonding may be incidental or eliminated altogether, if desired.

The filaments are then passed out of the first heating zone of the hot air knife or hot air diffuser 34 to a second wire 37 where the fibers continue to cool and where the below wire vacuum 30 is discontinued so as to not disrupt crimping. As the filaments cool, they will crimp in the z-direction, or out of the plane of the web, and form a high loft, low density nonwoven web.

The process line 10 further includes one or more bonding devices such as the through-air bonder 36. Through-air bonders are well-known to those skilled in the art and are not discussed here in detail. Generally described a through-air bonder 36 includes a perforated roller 38, which receives the web, and a hood 40 surrounding the perforated roller. A conveyor 37 transfers the web from the forming surface to the through-air bonder.

Lastly, the process line 10 includes a winding roll 42 for taking up the finished fabric, athough the finished fabric may be directed to another product. It should be understood; however, that other through-air bonding arrangements are suitable to practice the present invention. For example, when the forming surface is a belt, the forming surface can be routed directly through a more conventional through-air bonder.

Alternatively, when the forming surface is a drum, the through-air bonder can be incorporated into the same drum so that the web is formed and bonded on the same drum. Other bonding means such as, for example, oven bonding, or infrared bonding processes which effects interfiber bonds without applying significant compacting pressure may be used in place of the through air bonder.

To operate the process line 10, the hoppers 14a and 14b are filled with the respective polymer components A and B. Polymer components A and B are melted and extruded by the respective extruders 12a and 12b through polymer conduits 16a and 16b and the spinneret 18. Although the temperatures of the molten polymers vary depending on the polymers used, when polypropylene and polyethylene are used as component A and component B respectively, the preferred temperatures of the polymers range from about 370° F. (187° C.) to about 530° F. (276° C.) and preferably range from 400° F. (204° C.) to about 450° F. (232° C.).

As the extruded filaments extend below the spinneret 18, a stream of air from the quench blower 20 at least partially quenches the filaments to develop a latent helical crimp in the filaments. The quench air preferably flows in a direction substantially perpendicular to the length of the filaments at a temperature of about 45° F. (7° C.) to about 90° F. (32° C.) and a velocity from about 100 to about 400 feet per minute (about 30.5 to about 122 meters per minute). The filaments must be quenched sufficiently before being collected on the forming surface 26 so that the filaments can be arranged by the forced air passing through the filaments and forming surface. Quenching the filaments reduces the tackiness of the filaments so that the filaments do not adhere to one another too tightly before being bonded and can be moved or arranged on the forming surface during collection of the filaments on the forming surface and formation of the web.

After quenching, the filaments are drawn into the vertical passage of the fiber draw unit 22 by a flow of ambient air from the blower 24 through the fiber draw unit. The fiber draw unit is preferably positioned 30 to 60 inches (0.76 to 1.5 meters) below the bottom of the spinneret 18. The filaments are deposited through the outlet opening 23 of the fiber draw unit 22 onto the traveling forming surface 26, and as the filaments are contacting the forming surface, the vacuum 20 draws the filaments against the forming surface to form an unbonded, nonwoven web of continuous filaments.

As discussed above, because the filaments are quenched, the filaments are not too tacky and the vacuum can move or arrange the filaments on the forming surface as the filaments are being collected on the forming surface and formed into the web. If the filaments are too tacky, the filaments stick to one another and cannot be arranged on the surface during formation of the web.

After the filaments are collected on the forming surface, the filaments are optionally heat treated with using a hot air knife or a hot air diffuser 34. The heat treatment serves one of two functions. First, the heat treatment serves to activate the latent helical crimp. Second, the heat treatment may serve as a preliminary bonding for the nonwoven web so that the web can be mechanical handled through the forming apparatus without damage.

When the spunbond filaments are crimped, the fabric of the present invention characteristically has a relatively high loft and is relatively resilient. The helical crimp of the filaments creates an open web structure with substantial void portions between filaments and the filaments are bonded at points of contact of the filaments. The temperature required to activate the latent crimp of most bicomponent filaments ranges from about 110° F. (43.3° C.) to a maximum temperature at or about melting point of polymer component B. The temperature of the air from the hot air knife or hot air diffuser can be varied to achieve different levels of crimp. Generally, a higher air temperature produces a higher number of crimps. The ability to control the degree of crimp of the filaments is particularly advantageous because it allows one to change the resulting density, pore size distribution and drape of the fabric by simply adjusting the temperature of the heat treatment.

When preliminary bonding is desired or needed, a hot air knife or hot air diffuser 34 is desirably used and directs a flow of air having a temperature above the melting temperature of the lowest temperature melting component of the multicomponent filaments, which is the sheath component in a sheath core configuration, through the web and forming surface 26. Preferably, the hot air contacts the web across the entire width of the web. The hot air melts the lower melting point component and thereby forms bonds between the bicomponent filaments to integrate the web. For example, when polypropylene and polyethylene are used as polymer components, polyethylene should be the sheath component if the filaments are in a sheath/core multicomponent filament, the air flowing from the first through-air bonder preferably has a temperature at the web surface ranging from about 230° F. (110° C.) to about 500° F. (260° C.). and a velocity at the web surface from about 1000 to about 5000 feet per minute (about 305 to about 1524 meters per minute). It is noted; however, the temperature and velocity of the air from the hot air knife 34 may vary depending on factors such as the polymers which form the filaments, the thickness of the web, the area of web surface contacted by the air flow, and the line speed of the forming surface. It is noted that the if temperature of the air flowing from the hot air knife or the hot air diffuser is too hot, crimping of the filaments may not occur. Furthermore, the filaments may be heated by methods other than heated air such as exposing the filaments to electromagnetic energy such as microwaves or infrared radiation.

After the heat treatment of the filaments, the nonwoven web of filaments is then passed from the heat treatment zone of the hot air knife or hot air diffuser 34 to a second wire 37 where the fibers continue to cool and where the below wire vacuum 30 is discontinued. As the filaments cool and are removed from the vacuum, the filaments will crimp in the z-direction, or out of the plane of the web, thereby forming a high loft, low density nonwoven web 50.

After being optionally heat treated, the nonwoven web 50 is transferred from the forming surface 26 to the through-air bonder 36 with a conveyor 37 for more thorough bonding which will set, or fix, the web at a desired degree of loft and density achieved by the crimping of the filaments. In the through-air bonder 36, air having a temperature above the melting temperature of lower melting point component is directed from the hood 40, through the web, and into the perforated roller 38. As with the hot air knife 34, the hot air in the through-air bonder 36 melts the lower melting point component and thereby forms bonds between the bicomponent filaments to integrate the web. When polypropylene and polyethylene are used as polymer components A and B respectively, the air flowing through the through-air bonder preferably has a temperature ranging from about 230° F. (110° C.) to about 280° F. (138° C.) and a velocity from about 100 to about 500 feet per minute (about 30.5 to about 152.4 meters per minute). The dwell time of the web in the through-air bonder 36 is preferably less than about 6 seconds. It should be understood, however, that the parameters of the through-air bonder 36 also depend on factors such as the type of polymers used and thickness of the web.

As an alternative to the heating zone using a combination of a hot air knife or a hot air diffuser with the through air bonder, the through air bonding (TAB) unit 40 can be zoned to provide a first heating zone in place of the hot air knife or hot air diffuser 34, followed by a cooling zone, which is in turn followed by a second heating zone sufficient to fix the web. The fixed web 41 can then be collected on a winding roll 42 or the like for later use. In this configuration, when the web passes through a cool zone that reduces the temperature of the polymer below its crystallization temperature, the lower melting point polymer recrystallizes. In the case a bicomponent filament from polyethylene and polypropylene, since polyethylene is a semi-crystalline material, the polyethylene chains recrystallize upon cooling causing the polyethylene to shrink. This shrinkage induces a force on one side of the side-by-side or the eccentric sheath/core filaments that allows it to crimp or coil if there are no other major forces restricting the filaments from moving freely in any direction.

By using the unheated, approximately ambient FDU, in accordance with the above described process, the filaments are constructed so that they do not crimp in a tight helical fashion, which occurs for filaments processed through a normal heated FDU. Instead, the filaments more loosely and randomly crimp, thereby imparting more z-direction loft to the filaments. In addition to having a more loose and random crimp, the radius of the crimp generally tends to be larger as compared to filaments produced in a heated FDU. These properties result in a nonwoven web having a higher loft at a given basis weight, lower density at a given basis weight and more uniformity in the resulting nonwoven web when the post formation crimping process is used as compared to the activation of the crimp in the FDU.

Factors that can affect the amount and type of crimp include the dwell time of the web under the heat of the first heating zone. Other factors affecting crimp can include material properties such as fiber denier, polymer type, cross sectional shape and basis weight. Restricting the filaments with either a vacuum, blowing air, or bonding will also affect the amount of crimp and thus the loft, or bulk, desired to be achieved in the high loft, low density webs of the present invention. Therefore, as the filaments enter the cooling zone, no vacuum is applied to hold the fibers to the forming wire 26 or second wire 37. Blowing air is likewise controlled or eliminated in the cooling zone to the extent practical or desired.

According to one aspect of the present invention, the fibers may be deposited on the forming wire with a high degree of machine direction (MD) orientation as controlled by the amount of under-wire vacuum, the FDU pressure, and the forming height from the FDU to the wire surface. A high degree of MD orientation may be used to induce very high loft into the web, as further explained below. Further, dependent upon certain fiber and processing parameters, the air jet of the FDU will exhibit a natural frequency which may aid in the producing of certain morphological characteristics such as shingling effects into the loft of the web.

According to the exemplary embodiment of FIG. 1, wherein the filaments are heated by air flow in the first heating zone and passed by the forming wire 26 to the second wire 37, several crimping mechanisms are believed to take place to aid in the lofting of the fibers, including, without being bound by theory:
the below-wire exhaust will cool the web by drawing surrounding air through it which prevents bonding but restricts formation of loft,
as the web is transferred out of the vacuum zone to the second wire, the vacuum force is removed and the unconstrained fibers are free to crimp,
mechanically, MD surface layer shrinkage of a highly MD oriented surface layer may cause the surface fibers to buckle,
mechanical shearing will be induced because the highly MD oriented surface shirring and bonds will leave subsurface fibers to continue shearing thereby creating loft by inducing shingling of the layers,
a mechanical buckling pattern may be produced at the natural frequency of the FDU jet which will cause the heated fibers to loft in the same frequency,
mechanical forces are created as fibers release from the forming wire 26 when leaving the vacuum area and then are briefly pulled back towards the vacuum unit 30, and
a triboelectric (frictional) static charge is built up on the web and causes the fibers to repel each other allowing further loft within the web.

It has been discovered that the high loft material made by the process described above can be used to produce high loft, low density nonwoven web having a density as low as 1 kg/m³ and a bulk up to about 50 mm or more. If additional bulk is needed or desired, two or more of the high loft materials may be laminated together.

The layers of the laminate of the present invention can be adjoined by various means that intimately join the layers together. For example, the layers can be bonded to have uniformly distributed bond points or regions. Useful bonding means for the present invention include adhesive bonding, e.g., print bonding; thermal bonding, e.g., point bonding; and ultrasonic bonding processes, provided that the selected bonding process does not alter, e.g., diminish, the permeability or loftiness of the web layers or the interface of the layers to a degree that makes the laminate undesirable for its intended use. Alternatively, the layers can be bonded only at the peripheral edges of the media, relying on the pressure drop across the media during use to form joined laminates. As yet another alternative, the layers can be sequentially formed on a forming surface. In order to enhance bonding between the layers of the laminate, it may be desirable to add bonding agents to one or more polymer formulations and/or employ one or more tie layers between the fine fiber meltblown nonwoven web and high loft material. Thermal bonding in a through air bonder of the fine fiber meltblown nonwoven web may be used in applications especially where the mixture of different fibers employs polymers having different melting points and/or one or more polymers miscible with that of the high loft material. This can improve the strength and durability of the bond points as well as the integrity of the overall laminate. In addition, the layers of the laminate can be adhesively bonded together by applying an adhesive between the layers. Suitable adhesives include, but are not limited to, pressure sensitive adhesives and hot melt adhesives. These adhesives may be applied by any method known to those skilled in the art including, but not limited to, spraying, coating or printing. Desirable the adhesive is applied in a pattern as opposed to application across the entire surface of one or more layers of the laminate to help retain the permeability and pressure drop across the laminate.

Additional layers can also be laminated with the fine fiber meltblown nonwoven web and high loft material. As an example, an additional layer may be used to improve the overall strength of the acoustical insulation material, provided that the additional layers do not adversely affect the overall acoustical performance of the laminate. A lightweight spunbond layers may be used for this purpose. Additional layers may be an additional nonwoven web having a density of at least 50 kg/m³ and comprising thermoplastic fibers having an average fiber diameter of less than about 7 microns which is positioned on the side of the second layer which is opposite the side of the second layer which is joined to the first layer. This configuration would be advantageous in situations where sound may be generated from both sides of the acoustical insulation. The additional layers may also include, for example, films, other nonwovens, paper, woven materials, and the like.

In using the acoustical insulation of the present invention, the acoustical insulation is placed between a sound source area and a sound receiving area called the “second area”. The acoustical insulation attenuates the sound coming from the source area by absorbing the sound and/or by reflecting such sound waves outwardly and away from a receiving area.

The meltblown acoustical insulation of the present invention has both sound absorbing and sound reflecting capabilities.

Pressure drop is a measure of the force required to get a volume of air through a sheet. The acoustical insulation nonwoven web of the present invention preferably has a pressure drop at least about 1 mm water at a flow rate of about 32 liters/minute (“L/min.”).

More preferably, the pressure drop should be about 3 mm to about 12 mm water at a flow rate of about 32 L/min. The pressure drop is measured using ASTM F 779-88 test method.

The Frazier permeability of the meltblown nonwoven web acoustical insulation of the present invention should be less than about 75 cubic feet per minute per square foot (cfm/ft²) (about 22.9 cubic meters per minute per square meter (m³/min./m²). Ideally, the Frazier permeability should be less than about 50 cfm/ft² and preferably less than about 30 cfm/ft². The Frazier permeability was tested using a Frazier Air Permeability tester available from Frazier Precision Instrument Company and measured in accordance with Federal Test Method 5450, Standard No. 191A.

The acoustical insulation material of the present invention can be used in a wide variety of locations where sound attenuation is desired. Examples of possible uses include articles such as small appliances, large appliances, vehicles such as cars, airplanes and the like, architectural applications such as in homes, commercial buildings and in heating, venting and air conditioning systems (HVAC).

The acoustical insulation material of the present invention were tested for absorption using a Model # 4206 impedance tube available from Bruel & Kjaer. The test procedures in accordance with ASTM E1050-98 were followed. The absorption coefficient was recorded and graphed. The acoustical insulation material of the present invention is effective in attenuating sound up to and beyond 6.3 kHz

### EXAMPLES

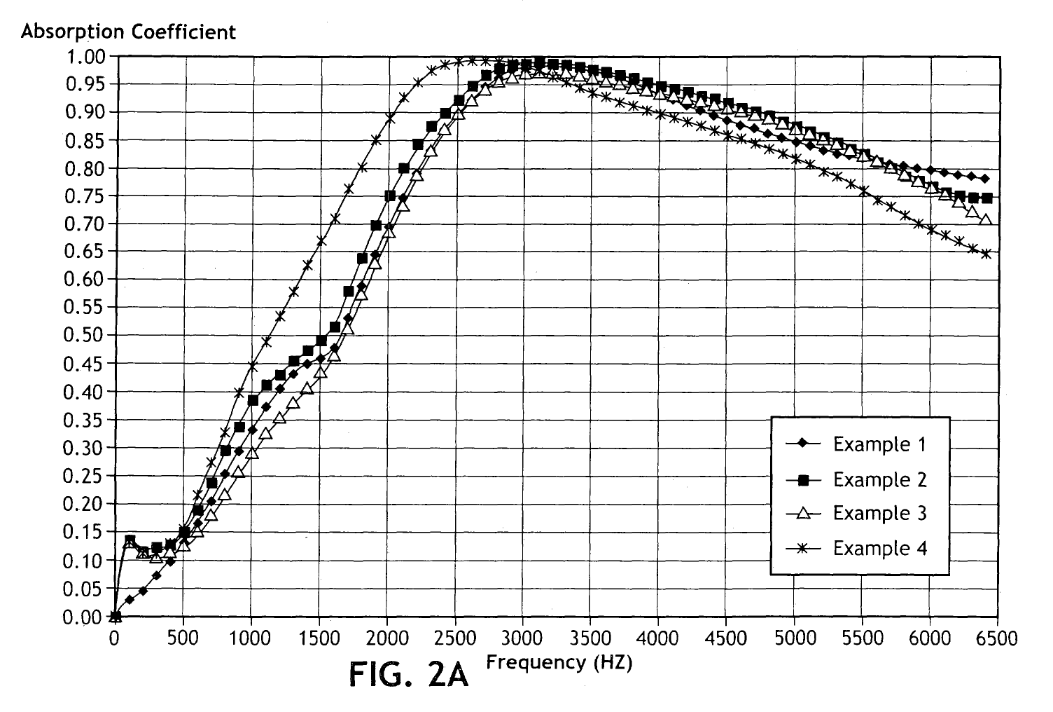

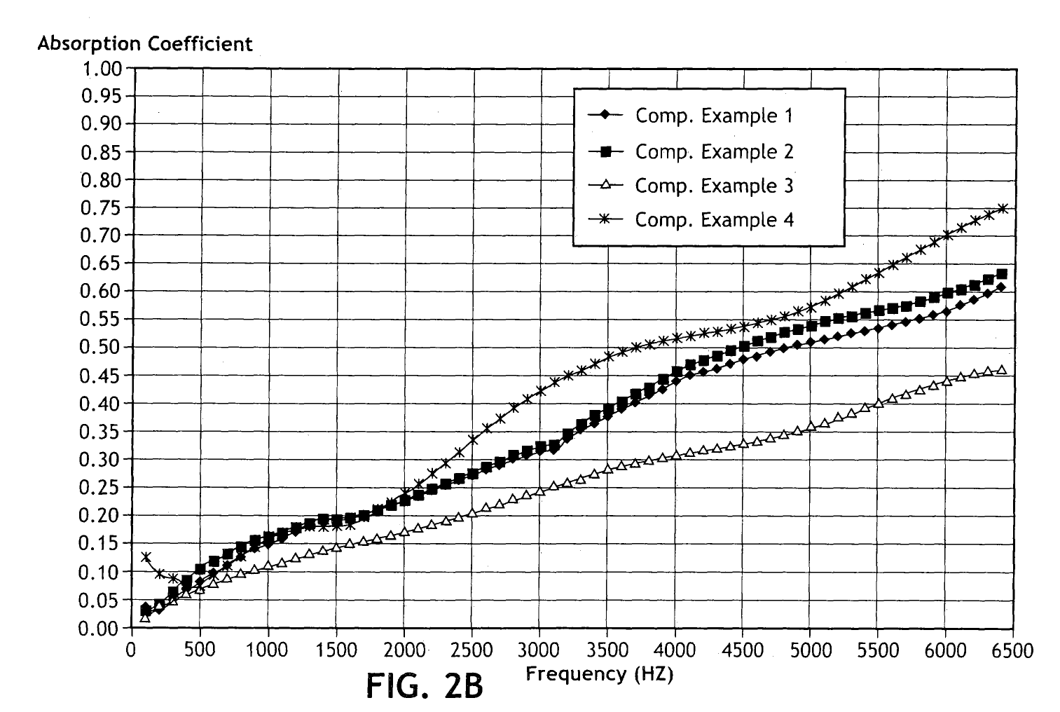

Different materials were laminated to a fine fiber meltblown nonwoven web having fiber with an average fiber diameter of about 3 microns, a basis weight of 60 grams per square meter (gsm), a bulk of 0.064 cm and a density of about 94 kg/m³ available from Kimberly-Clark Corporation, Roswell, Ga. Each of the materials was tested individually for comparative purposes to show the effect of the laminate as compared to the high loft material alone. The materials were tested in accordance with ASTM E1050-98 using a Model #4206 impedance tube available from Bruel & Kjaer. The results of the absorption testing are shown in FIG. 2A and FIG. 2B. FIG. 2A graphically shows the absorption coefficient over a range of frequencies tested for the acoustical insulation laminate of the present invention and FIG. 2B graphically shows the absorption coefficient over a range of frequencies tested for the high loft or second layer material alone, without the fine fiber high density layer.

In Example 1 and comparative Example 1, the high loft material was fiberglass, having a basis weight of 345 gsm, a bulk 1.91 cm, and a bulk density of 18 kg/m³ sold under the tradename Frost King available from Thermwell Products, Patterson, N.J.

In Example 2 and comparative Example 2, the high loft material was a crimped filament bicomponent nonwoven web having a basis weight of 204 gsm, a bulk 1.27 cm, and a bulk density of 16 kg/m³ prepared using the process of FIG. 1 described above. The filaments were side-by-side bicomponent having a component of polypropylene and a component of polyethylene.

In Example 3 and Comparative Example 3, the high loft material was a high loft polyester nonwoven web available from Vita Nonwovens, High Point, N.C., under the tradename VITA. The material has a basis weight of 266 gsm, a bulk 1.27 cm, and a bulk density of 20 kg/m³

In Example 4 and Comparative Example 4, the high loft material was thru-air bonded carded web from staple fibers containing a blend of 60% 3 denier polyester crimped staple fibers and 40% 0.9 denier PE/PP bicomponent fibers available Kimberly-Clark Corporation, Roswell, Ga. The material has a basis weight of 119 gsm, a bulk 0.48 cm, and a bulk density of 25 kg/m³.

As can be seen in FIGS. 2A and 2B, the laminate of the meltblown and the high loft material had a higher absorption coefficient than the high loft material alone. This shows that the laminate has superior acoustical absorption properties as compared to some conventionally used acoustical insulation materials.

While the invention has been described in detail with respect to specific embodiments thereof, and particularly by the example described herein, it will be apparent to those skilled in the art that various alterations, modifications and other changes may be made without departing from the spirit and scope of the present invention. It is therefore intended that all such modifications, alterations and other changes be encompassed by the claims.

1. An acoustical insulation material comprising
a first layer comprising a nonwoven web having a density of at least 50 kg m³ and comprising thermoplastic fibers having an average fiber diameter of less than about 7 microns; and
a second layer comprising a high loft material.

2. The acoustical insulation material of claim 1, wherein the first layer has a thickness less than about 3 mm.

3. The acoustical insulation material of claim 1, wherein the thermoplastic fibers of the first layer have an average fiber diameter of less than about 5 microns.

4. The acoustical insulation material of claim 2, wherein the thermoplastic fibers of the first layer have an average fiber diameter of about 1.0 microns to about 4.0 microns.

5. The acoustical insulation material of claim 2, wherein the thickness of the first layer is between about 0.2 mm to about 2.5 mm and the density of the nonwoven web of the first layer is between about 55 kg/m³ and about 150 kg/m³.

6. The acoustical insulation material of claim 5, wherein the thickness of the first layer is between about 0.3 mm to about 1.0 mm and the density of the nonwoven web of the first layer is between about 58 kg/m³ and about 100 kg/m³.

7. The acoustical insulation material of claim 1, wherein the thermoplastic fibers of the first layer comprise meltblown fibers of a thermoplastic polymer selected from the group consisting of selected from the group consisting of polyolefins, polyesters, polyamides, polycarbonates, polyurethanes, polyvinylchloride, polytetrafluoroethylene, polystyrene, polyethylene terephathalate, polylactic acid and copolymers and blends thereof.

8. The acoustical insulation material of claim 7, wherein the thermoplastic polymer comprises a polyolefin.

9. The acoustical insulation material of claim 8, wherein the polyolefin comprises polypropylene.

10. The acoustical insulation material of claim 1, wherein the material has a pressure drop
of at least 1 mm of water at a flow rate of about 32 liters/min.

11. The acoustical insulation material of claim 10, wherein the pressure drop is between about 3 mm and about 10 mm of water at a flow rate of about 32 liters/min.

12. The acoustical insulation material of claim 1, wherein the thermoplastic meltblown fibers of the first layer comprise monocomponent fibers.

13. The acoustical insulation material of claim 1, wherein the thermoplastic [meltblown] fibers of the first layer comprise multicomponent fibers.

14. The acoustical insulation material of claim 13, wherein the multicomponent fibers are meltblown.

15. The acoustical insulation material of claim 13, wherein the multicomponent fibers have a side-by-side configuration.

16. The acoustical insulation material of claim 15, wherein the multicomponent fibers comprises at least one component comprising polyethylene and at least one component comprising polypropylene.

17. The acoustical insulation material of claim 13, wherein the multicomponent fibers are splitable.

18. The acoustical insulation material of claim 13, wherein the thickness of the first layer is between about 0.2 mm to about 2.5 mm and the density of the nonwoven web of the first layer is between about 55 kg/m³ and about 150 kg/m³.

19. The acoustical insulation material of claim 1, wherein the high loft material is selected from the group consisting of fiberglass, a high loft spunbond nonwoven web, a bonded carded web and a polyester high loft.

20. The acoustical insulation material of claim 19, wherein the high loft material comprises a high loft spunbond nonwoven web.

21. The acoustical insulation material of claim 20, wherein the high loft spunbond nonwoven web comprises crimped multicomponent filaments.

22. The acoustical insulation material of claim 21, wherein the crimped multicomponent filaments have latent crimp which is activated when the multicomponent filaments are in a fiber draw unit.

23. The acoustical insulation material of claim 21, wherein the crimped multicomponent filaments have latent crimp which is activated after the multicomponent filaments are laid-down on a forming wire.

24. The acoustical insulation material of claim 21, wherein the crimped multicomponent filaments comprise a side-by-side configuration.

25. The acoustical insulation material of claim 24, wherein the crimped multicomponent filaments have latent crimp which is activated after the multicomponent filaments are laid-down on a forming wire.

26. The acoustical insulation material of claim 19, wherein the thickness of the second layer is at least 4 mm.

27. The acoustical insulation material of claim 26, wherein the thickness of the second layer is between about 5 mm and about 200 mm.

28. The acoustical insulation material of claim 27, wherein the thickness of the second layer is between about 9 mm and about 100 mm.

29. The acoustical insulation material of claim 26, wherein the thickness of the second layer is between about 12 mm and about 25 mm.

30. The acoustical insulation material of claim 19, wherein the high loft material comprises rotary spun bicomponent fibers.

31. The acoustical insulation material of claim 30, wherein the rotary spun bicomponent fibers are bicomponent glass fibers.

32. The acoustical insulation material of claim 13, wherein the density of the second layer is less than about 50 kg/m³.

33. The acoustical insulation material of claim 32, wherein the density of the second layer is less than about 25 kg/m³.

34. The acoustical insulation material of claim 33, wherein the density of the second layer is between about 1.5 kg/m³ and about 20 kg/m³.

35. The acoustical insulation material of claim 1, further comprising a third layer attached either to the first layer or the second layer.

36. The acoustical insulation material of claim 35, wherein the additional layer comprises a nonwoven web having a density of at least 50 kg/m³ and comprising thermoplastic fibers having an average fiber diameter of less than about 7 microns and the additional layer is attached to the second layer.

37. A method of attenuating sound waves passing from a sound source area to a second area comprising positioning the acoustical insulation material of claim 1 between the sound source area and the second area.
